(19) United States
(12) Patent Application Publication
(10) Pub. No.: US 2007/0214674 A1
(43) Pub. Date: Sep. 20, 2007

(54) Tape measure

(76) Inventors: Gregory J. Erisoty, Riverton, CT (US); Raymond Joseph MacQueen JR., New Hartford, CT (US)

Correspondence Address: TED PAULDING, 10 PENWOOD LA., WETHERSFIELD, CT, 06109, US

(21) Appl. No.: 11/378,042

(22) Filed: Mar. 17, 2006

(51) Int. Cl. G01B 3/10

(52) U.S. Cl. 33/761

(57) ABSTRACT

An improved tape measure having a writing surface on one side wall and an auxiliary member hingedly attached to said side wall and providing two additional writing surfaces. An angular series indicia on an end wall adjacent an edge of the auxiliary provides for the ready measurement of the angular relationship between the side wall and the auxiliary member and thus enables a tradesman to measure the angular relationship of adjacent elements.

### BACKGROUND OF INVENTION

Carpenters, roof and siding installation tradesmen and others frequently need something on which they can enter notes such as measurements, angles, etc., and often do not carry note pads or the like. Most of us have seen small scraps of wood used for this purpose. On the other hand, the tradesmen referred to are almost never without their tape measures. It is therefor the general object of the present invention to provide an improved tape measure with note taking capability.

### SUMMARY OF THE INVENTION

In fulfillment of the aforementioned general object and in accordance with the present invention, a tape measure is provided with the conventional elongated thin flat measuring tape which is coiled upon itself and which has indicia there along for measuring when in an extended attitude. A conventional housing for the tape has relatively narrow top and bottom and opposing end walls and relatively broad opposing side walls, one of the end walls having an opening through which the tape can be extended and withdrawn. At least one of the side walls has an exposed writing surface of a material adapted to receive and retain indicia from a conventional writing instrument which can be readily viewed with the human eye and readily erased.

Preferably, an auxiliary member is provided in association with one of said side walls and carries at least one additional indicia receptive writing surface. Further, the auxiliary member is preferably swingably attached to said one side wall and has a spring-biased hinge urging the member towards its closed position adjacent the side wall. Other means of mounting the member such as a sliding arrangement are also contemplated.

Still further, one of the housing walls preferably carries an arcuate series of angular indicia in the nature of a protractor. As shown, the arcuate series of angular indicia is located on an end wall of the housing immediately adjacent the hinged end of the auxiliary member so that one edge portion of the member forms a continuation of selected angular indicia of the series of indicia. The angle of the auxiliary member relative to its adjacent wall is thus readily determined.

Optionally, a small pointer element is provided on the auxiliary member adjacent and in alignment with said one edge of the member and extends toward said series of angular indicia to facilitate determination of the angular relationship of the member and the adjacent wall.

Finally, the indicia receptive material may vary widely in composition but is preferably of a thermoplastic or metallic composition.

### DESCRIPTION OF THE DRAWINGS

FIG. 1 is a perspective view of the improved tape measure constructed in accordance with the present invention with its auxiliary member in an open position,

FIG. 2 is a perspective view of the improved tape measure of FIG. 1 with its auxiliary member in a closed position,

FIG. 3 is a perspective view of improved tape measure similar to FIGS. 1 and 2 but showing the tape measure in a reverse position, and

FIG. 4 is a plan view of the auxiliary member of FIGS. 1-3.

### DESCRIPTION OF PREFERRED EMBODIMENT

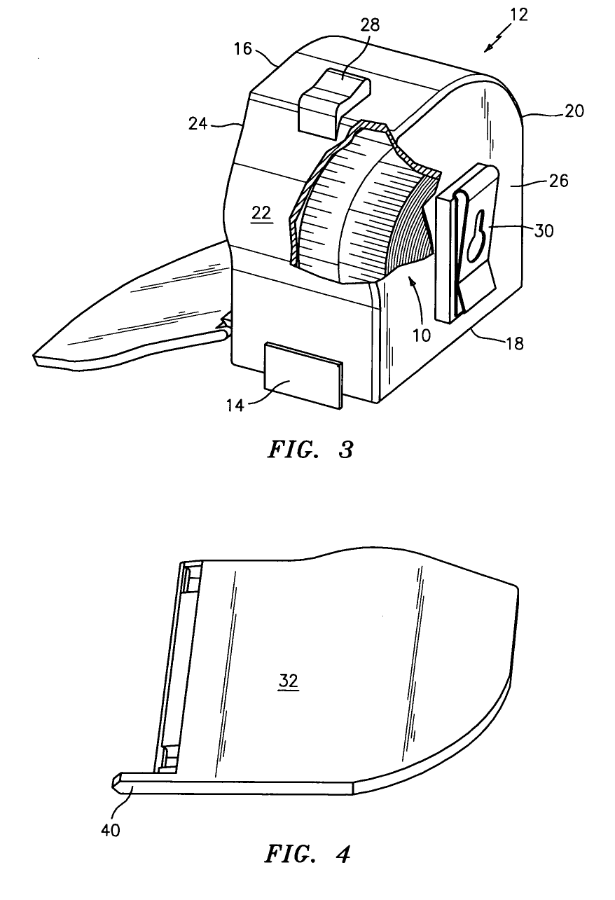

Referring initially to FIGS. 1 and 3, a conventional elongated thin flat measuring tape is illustrated generally at 10 within a housing illustrated generally at 12. The tape is coiled upon itself within the housing which has an opening (not shown) behind a small tab 14 fixed to the free end of the tape and which facilitates manual manipulation and withdrawal of the tape from the housing for a measuring operation. The housing has relatively narrow top, bottom and opposing end walls. 16, 18, 20 and 22 and relatively broad opposing front and rear side walls 24, and 26 complete a more or less conventional housing construction.

A release button 28 on the top wall is also conventional and allows a spring return mechanism (not shown) to rewind the tape measure to the position shown in FIG. 3 when actuated by the tape operator. Also in FIG. 3, a clip 30 enables the operator to mount the tape measure on his belt or other convenient strap-like member for ready availability.

Reverting now to FIG. 1, it will be observed that the front wall 24 the housing is provided in a clean form devoid of the usual manufacturer's logo or the like. The reason for this is the adaptation of the front wall as a note-taking or writing surface adapted to receive and retain indicia from a conventional writing instrument, the indicia being readily viewed with the human eye and readily erased. The writing surface may vary widely, but is preferably of thermoplastic or metallic composition so as to be weather resistant and durable over a long life.

An important aspect of the invention resides in the provision of an auxiliary member 32 preferably swingably attached to one side wall of the housing, the side wall 24 in FIG. 1, and which also carries at least one additional indicia receptive writing surface. As shown, the member 32 has indicia receptive writing surfaces on both sides and thus greatly expands the area available to a tradesman for note-taking. The surfaces on the front and back sides of the 32 may be the same composition as the surface of the wall 24.

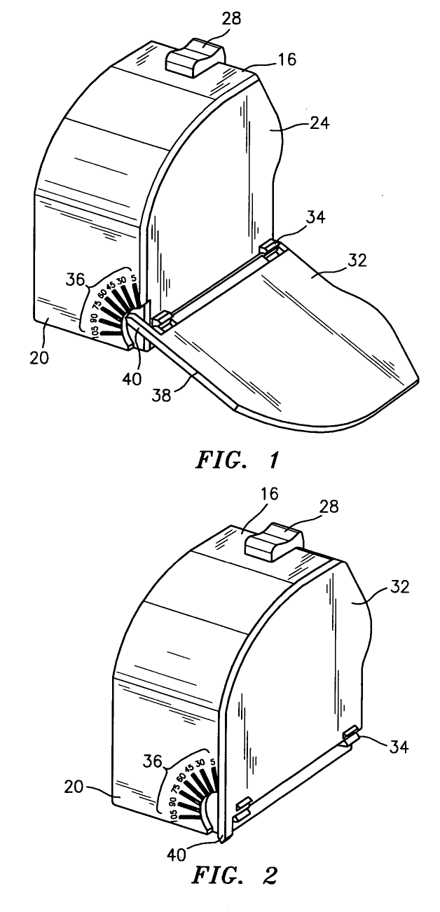

Preferably, a spring-biased hinge device 34 is mounted at the bottom of the wall 24 and maintains 32 in its closed position as shown in FIG. 2 when its rear surface and the surface of the wall 24 are not needed for note-taking.

As illustrated in FIGS. 1 and 2, an arcuate series of angular indicia 36 in the nature of a protractor is provided adjacent the bottom of the end wall 20. The angular indicia are shown in increments of 15 degrees running from 15 degrees to 105 degrees and an edge portion 38 of the auxiliary member 32 aligns with and forms a continuation of selected angular indicia in the series of indicia. Thus, the angle of the auxiliary member relative to its adjacent wall 24 can be readily determined.

Optionally, a small pointer element 40 can be provided on the auxiliary member 32 in alignment with its edge 38 and extending toward the series of angular indicia to facilitate determination of the angular relationship of the member and adjacent wall.

As will be apparent from the foregoing, an improved tape measure has been provided wherein ample space for note-taking is available to the tradesman onsite and wherein the determination of angular relationships is greatly facilitated, angularly related elements being aligned respectively with the side wall 24 and the auxiliary member 32. The tape measure is of simple and yet highly efficient construction and may be expected to offer a high degree of durability and long life.

1. An improved tape measure comprising an elongated thin flat measuring tape coiled upon itself and having indida there along for measuring when in an extended attitude, and a housing for the tape having relatively narrow top, bottom and opposing end walls and relatively broad opposing side walls, one of said end walls having an opening through which the tape can be extended and withdrawn, and at least one of said side walls having an exposed writing surface of a material adapted to receive and retain indicia from a conventional writing instrument readily viewed with the human eye and which can be readily erased.

2. An improved tape measure as set forth in claim 1 wherein an auxiliary member is provided on one of said side walls and carries at least one additional indicia receptive writing surface.

3. An improved tape measure as set forth in claim 2 wherein said auxiliary member is swingably attached to said one side wall.

4. An improved tape measure as set forth in claim 3 wherein said swingable member has a spring biased hinge urging the member toward its closed position adjacent the side wall.

5. An improved tape measure as set forth in claim 4 wherein one of said walls carries an arcuate series of angular indicia in the nature of a protractor.

6. An improved tape measure as set forth in claim 5 wherein said arcuate series of angular indicia are located on an end wall of the housing so as to be immediately adjacent the hinged end of the auxiliary member with one edge portion of the member forming substantially a continuation of selected angular indicia in the series of indicia, the angle of the auxiliary member relative to its adjacent wall thus being readily determined.

7. An improved tape measure as set forth in 6 wherein a small pointer element is provided on said auxiliary member adjacent and in alignment with said one edge of the member and extends toward said series of angular indicia to facilitate determination of the angular relationship of the member and adjacent wall.

8. An improved tape measure as set forth in claim 1 wherein said indicia receptive material is a thermoplastic.

9. An improved tape measure as set forth in claim 1 wherein said indicia receptive material is of metallic composition.
